(19) United States
(12) Patent Application Publication
(10) Pub. No.: US 2006/0267308 A1
(43) Pub. Date: Nov. 30, 2006

(54) Lighted step for a recreational vehicle

(76) Inventors: Daniel L. Decker JR., Castle Rock, CO (US); Alec D. Brock, Black Forest, CO (US); Jeffery T. Samson, Boulder, CO (US); Zach Conrad, Northglenn, CO (US); Randall W. Nichols, Denver, CO (US); John L. Goers, Castle Rock, CO (US)

Correspondence Address: SHERIDAN ROSS PC, 1560 BROADWAY, SUITE 1200, DENVER, CO, 80202, US

(21) Appl. No.: 11/137,933

(22) Filed: May 25, 2005

(51) Int. Cl. B60R 3/00

(52) U.S. Cl. 280/166

(57) ABSTRACT

A step lighting assembly is provided that is adapted for interconnection to a retractable step assembly generally found on recreational vehicles. One embodiment of the present invention includes a light bar with at least one motion sensor interconnected to a light source. The light bar thus provides light that illuminates the edge of the step when one approaches the vehicle or exits the vehicle thereby increasing safety.

### FIELD OF THE INVENTION

The present invention is generally related to a lighted step that is quickly and easily interconnected to retractable steps found on many recreational vehicles. One embodiment of the present invention includes at least one motion sensor that activates an integrated light source when an individual approaches the step.

### BACKGROUND OF THE INVENTION

Recreational vehicles are widely used as a means for providing an individual a home away from home on extended cross-country or camping trips. Recreational vehicles used today are equipped with a plurality of appliances and have living and sleeping areas wherein individuals may spend a great deal of time. Many vacationers choose to see the United States or other countries via the open road wherein recreational vehicles are used to provide almost all the comforts of home.

Recreational vehicles often have an increased wheel height to provide adequate ground clearance, to navigate a camp ground with rough terrain, for example. In order to provide access to the entrance of the recreational vehicle, most are equipped with stairs. In addition, stairs of many recreational vehicles include a plurality of selectively deployable steps that are activated manually or automatically. Although recreational vehicles are described herein, one skilled in the art will appreciate that the present invention as described herein will also apply to campers, fifth wheels, travel trailers, pop-up trailers or any vehicle with high ground clearance where steps and/or stairs are required or desired for ingress or egress.

When camping, artificial outside lighting is often scarce making entry into and exit from the recreational vehicle dangerous. Often, one must carry a lamp or a flashlight to ensure safe exit from and entry into the recreational vehicle. Some steps include lighting or reflecting devices to increase safety, thereby substantially preventing dangerous falls. There are several drawbacks of these lights. First, these lighting systems are operated by a switch, which is either on or off. Thus, the lights will usually be off when the trailer is parked. If on when parked, the lights are constantly on and needlessly draw on often limited power supplies. Secondly, OEM lights are often expensive and difficult to replace as they are integrated directly into the factory-supplied step. In addition, they are also prone to damage when the step assembly is folded under the recreational vehicle, perhaps adjacent to the wheels of the recreational vehicle, wherein the odds gravel impingements are increased.

Thus, it is a long felt need in the field of outdoor recreation to provide a step for the ingress and egress of a recreational vehicle that provides a method of indicating the edge of the step to increase safety. The following disclosure describes an improved system for integration onto an existing step assembly generally found on recreational vehicles that increases safety by indicating the edge of the step and by increasing traction on the step as a whole.

### SUMMARY OF THE INVENTION

It is one aspect of the present invention to provide a step assembly with a light source. More specifically, one embodiment of the present invention increases safety by providing a light source that is integrated onto a tread plate for interconnection onto a step of a step assembly commonly used on recreational vehicles. Preferably, the light source is a bar that is aligned with a front surface of the step. The light bar may include a plurality of motion sensors such that the light source illuminates when an individual attempts to enter or exit the recreational vehicle. Thus, a system is provided wherein the edge of the step is indicated so that the individual does not skip a step or misstep, actions that may cause injuries. In addition, as an added benefit, the present invention increases the width of the step such that a greater landing surface is provided.

It is another aspect of the present invention to provide additional treads to increase traction. One embodiment of the present invention includes a tread plate with a plurality of treads integrated thereon. These treads will generally increase the amount of traction afforded to the user such that slippage is greatly decreased.

It is still yet another aspect of the present invention to provide a lighted step assembly that is quickly and easily interconnected to the existing steps of a recreational vehicle. More specifically, one embodiment of the present invention is easily interconnected to the existing steps with fasteners. As an ancillary benefit, this quick and easy interconnection allows for the lighted step assembly to be removed prior to transport wherein potential damage from gravel impingement is alleviated. Also, the method of interconnecting the light bar and tread plate to the existing steps of the recreational vehicle provides a system that is easy to replace if damage should occur.

It is yet another aspect of the present invention to provide a light source that includes a power source that is easy to replace. More specifically, one embodiment of the present invention utilizes six AA batteries that are easily accessed through an end cap of the light bar which allows the user to simply remove the end plate and replace batteries that are required without having to remove the light bar from the tread plate. Alternatively, one skilled in the art will appreciate that other power sources, such as hardlines into the power sources of the recreational vehicle, solar power cells or external generators may be utilized without departing from the scope of the invention.

It is still yet another aspect of the present invention to provide a tread plate that includes a location for personalization. More specifically, one embodiment of the present invention includes a name plate such that the user may personalize their step akin to a welcome mat. Preferably, the user would place their family name or other symbol to provide an aesthetically pleasing step.

It is still yet another aspect of the present invention to provide a step assembly constructed from common materials and thus less expensive to manufacture. More specifically, embodiments of the present invention are fabricated of lightweight materials such as aluminum, steel, plastics, or any combination thereof, that are durable yet easy to maintain and clean. The lightweight and durable nature of the materials also allows the present invention to be constructed of a low profile wherein it substantially does not interfere with the retractable nature of many step assemblies commonly found on recreational vehicles. The commonality of the materials also allows the system to be constructed in an inexpensive manner such that replacement parts can be easily obtained and expense to the user will be minimized.

The Summary of the Invention is neither intended nor should it be construed as being representative of the full extent and scope of the present invention. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention. Additional aspects of the present invention will become more readily apparent from the Detail Description, particularly when taken together with the drawings.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is a perspective view of one embodiment of the present invention interconnected to a retractable step assembly commonly employed on a recreational vehicle;

FIG. 2 is a perspective view of one embodiment of the present invention; and

FIG. 3 is a perspective view of a light bar of the embodiment shown in FIG. 2.

To assist in the understanding of the present invention the following list of components and associated numbering found in the drawings is provided herein:

| # | Component |
|---|---|
| 2 | Step lighting assembly |
| 4 | Step |
| 6 | Tread plate |
| 8 | Step upper surface |
| 10 | Retractable step assembly |
| 12 | Aperture |
| 14 | Fastener |
| 16 | Stud |
| 18 | Light bar |
| 20 | Light |
| 22 | Motion sensor |
| 24 | Name plate |
| 26 | Tread |
| 28 | Lip |
| 30 | Step front surface |
| 32 | End cap |
| 34 | End cap fasteners |

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

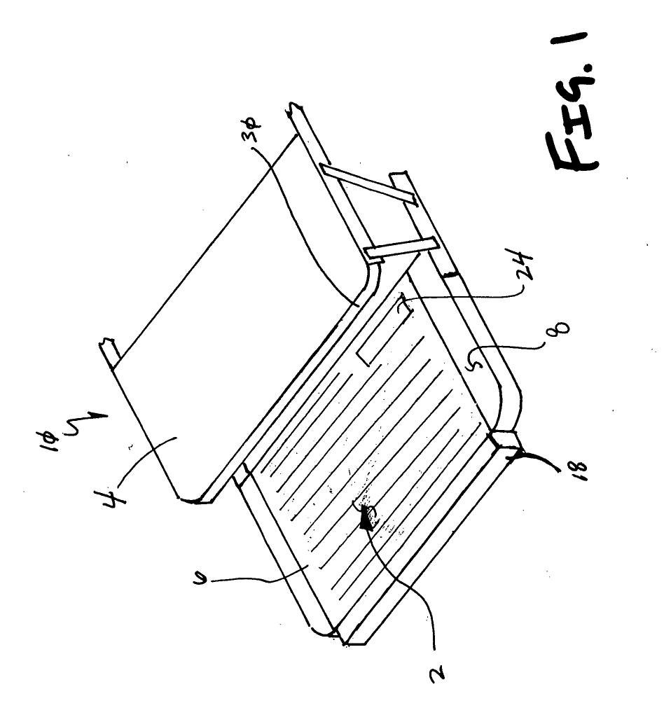

Referring now to FIGS. 1-3, a step lighting assembly 2 adapted for interconnection to a step 4 generally found on recreational vehicles is shown. More specifically, one embodiment of the present invention includes a tread plate 6 for engagement to an upper surface 8 of a step that is part of a retractable step assembly 10 generally found on recreational vehicles. The tread plate 6 may include a plurality of apertures 12 for the engagement of fasteners 14 and/or studs 16. In addition, a light bar 18 is included that includes studs 16 that are threaded through the apertures 12 of the tread plate 6 and are interconnected with fasteners 14 to the step 4. Further, the light bar 18 includes a lighting mechanism 20 and at least one motion sensor 22 wherein movement in the general vicinity of the light bar 18 will cause the light source 20 to illuminate, thus indicating the edge of the step 4. Thus, a step light assembly 2 is provided that increases the traction and width of the step 4, and provides an indication of the edge of the step 4 such that individuals entering and exiting the recreational vehicle at night may more easily ascertain their path.

Referring now to FIG. 1, a retractable step assembly 10 commonly employed on recreational vehicles is shown. Here, a retractable step assembly 10 that includes a plurality of steps 4 is shown that selectively deploys when the door of the recreational vehicle is opened. Alternatively the retractable step assembly 10 may be manually or otherwise automatically deployed. In addition, the step lighting assembly 2 of one embodiment of the present invention is shown interconnected to at least one step 4. The step lighting assembly 2 includes a tread plate 6 that lies on an upper surface 8 of the step and a light bar 18 that engages the tread plate 6 and the step 4 to increase the width of the step 4, in one embodiment of the present invention by at least about 12%. The structural integrity of the studs 16, which will be explained in more detail below, and the interconnection scheme with the step, will generally dictate the weight limit that will limit the width of the light bar. Further, a name plate 24 may be included on the tread plate 6 to customize the step lighting assembly 2 to the user's taste. Finally, the tread plate 6 may include non slip durable treads 26 integrated thereon to increase traction.

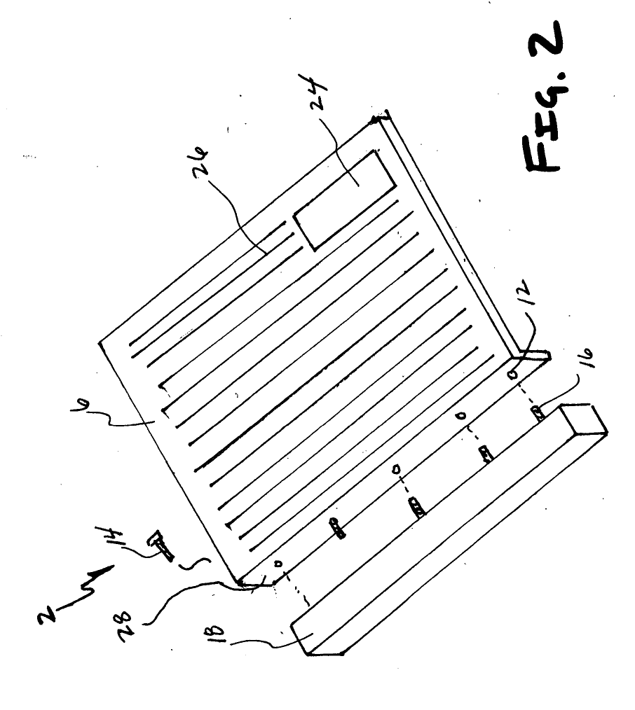

Referring now to FIG. 2, one embodiment of a stop lighting assembly is shown that includes the tread plate 6 and the light bar 18 that are adapted for interconnection to a step of the recreational vehicle. In the illustrated embodiment, the tread plate 6 includes a plurality of treads 26 to increase the traction. In addition, the name plate 24 is included wherein the user may customize their step lighting assembly 2. The tread plate 6 is generally comprised of a plate for engagement to the step that is interconnected via a 90° bend to a lip 28 that includes a plurality of apertures 12. The apertures are adapted to receive fasteners 14 and/or studs 16 integrated into the light bar 18. The fasteners 14 are threaded through a front surface of the step, as shown in FIG. 1, and into the light bar 18. Alternatively, the light bar may include fixed studs 16 that are threaded through the lip 28 of the tread plate and through apertures integrated into the step assembly, wherein nuts would be fastened thereto to secure the light bar 18 onto the tread plate 6 and the step.

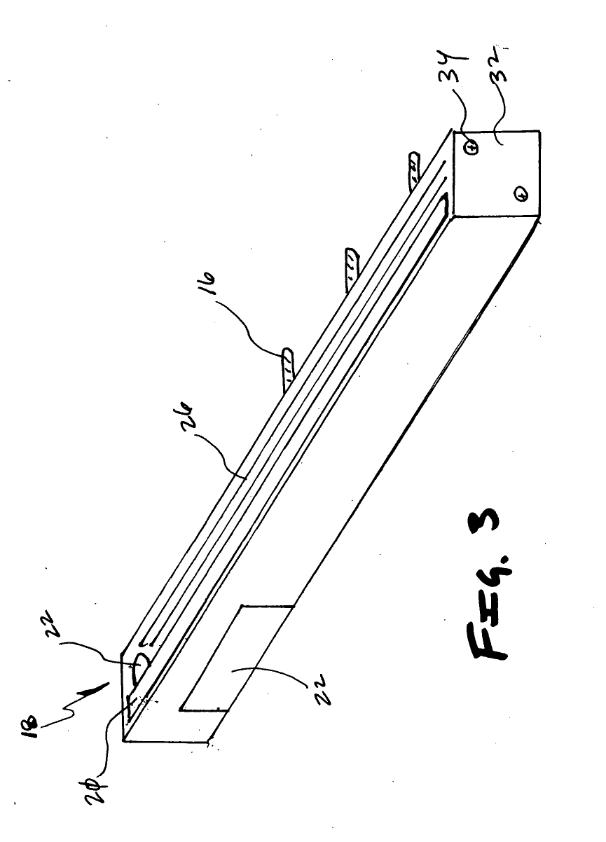

Referring now to FIG. 3, a light bar 18 of one embodiment of the present invention is shown. In accordance with embodiments of the present invention, a light bar 18 is provided that includes at least one motion sensor 22. Here, the motion sensor 22 is integrated onto the top surface and onto a front surface of the light bar 18. The motion sensors 22 are operatively interconnected to the light source 20 that is integrated on the top surface of the light bar. One skilled in the art will appreciate that the light source 20 may be interconnected to any surface of the light bar 18 or alternatively a plurality of light sources maybe employed on the light bar 18. Also, one should understand that a manual switch may be included, which may be remotely controlled, such that the light source 20 may be continually or selectively operated depending on the user's wishes. The light bar 18 may also include treads 26 to increase the traction provided thereby. Further, the light bar 18 may include a plurality of studs 16 emanating from a back side that are adapted to be threaded through apertures incorporated into the lip of the tread plate and through the front surface of the step wherein nuts are used to secure the light bar 18 onto the tread plate and the step. Alternatively, the light bar 18 may include a plurality of threaded apertures (not shown) that are positioned in-line with the studs 16. The threaded apertures would receive fasteners that are threaded through apertures integrated on the front surface of the recreational vehicle step, through the lip of the tread plate, and into the threaded holes of the light bar. Finally, an end cap 32 is provided that is interconnected and secured onto the light bar 18 with a plurality of fasteners 34. The end cap 32 is used to cover a power source storage cavity. In one embodiment of the present invention, a plurality of batteries, for example, six AA batteries, are inserted into the light bar 18. Alternatively, one skilled in the art will appreciate that other power sources, such as different sized batteries, solar power, piezoelectric power, battery power from the recreational vehicles engine, wind power, etc., may be employed, wherein the power is either stored or used directly from a power source, without departing from the scope of the invention.

Referring now to FIGS. 1-3, the process of using and employing one embodiment of the present invention is shown. More specifically, in order to interconnect the step lighting assembly 2 onto the step 4 of the recreational vehicle, initially the tread plate 6 is placed on the step 4, wherein the lip 28 is engaged onto the front surface 30 of the step. The locations of the apertures 12 are then marked on the front surface 30 of the step through the apertures 12 of the tread plate 6, thus indicating where apertures through the front surface 30 of the step are required to be drilled or punched. The tread plate 6 is then removed and five apertures are drilled through the front surface 30 of the step with preferably a 7/32″ drill bit. It should be noted, that other items that are generally included on the step 4 may have to be removed in order to ensure that the tread plate 6 will be securely fastened to the step. For example, many steps 4 already include treads or material glued thereon to ensure that traction is maximized. One skilled in the art will appreciate that these items may have to be removed prior to interconnecting the step lighting assembly 2 onto the step 4. After the apertures are drilled, the tread plate 6 is placed back on the step 4 and the apertures 12 aligned with the apertures previously drilled into the front surface 20 of the step. The light bar 18 is then engaged onto the lip 28 of the tread plate 6 wherein the studs 16 of the light bar 18 are threaded through the apertures 12 of the tread plate 6. Nuts are then used to secure the studs 16 of the light bar 18. In addition, a plurality of fasteners 4 are threaded through the underside of the step 4 into the threaded apertures of the light bar 18 and all fasteners are tightened. Finally, the end cap fasteners 34 are removed and a plurality of batteries are inserted into the light bar 18 and the end cap 32 reattached, thus providing a power source to the light bar 18.

The materials of the step lighting assembly are commonly used and thus it is envisioned that the system is inexpensive and less difficult to manufacture. More specifically, the tread plate 6 may be constructed from steel, aluminum, plastic, or any similar material. The treads 26 of the system are simply grooves integrated into the top surface of the tread plate 6. Although horizontal grooves are shown, one skilled in the art will appreciate that any type of groove may be provided that increases the traction and/or the aesthetics of the tread plate 6, such as diamond plating or diagonal grooves. In addition, one skilled in the art will appreciate that surface tread may be alternatively interconnected via fasteners or adhesives to the top surface of the tread plate 6, without departing from the scope of the invention.

The light bar 18 is preferably a mechanism for housing the light source 20, which is generally a light bulb or series of light emitting sources. Indeed, one skilled in the art will appreciate that light emitting diodes, liquid crystal displays or any similar lighting device maybe used without departing from the scope of the invention. In addition, commonly used motion detectors are employed. In one embodiment of the present invention motion sensors 22 are integrated onto the front surface and the top surface of the light bar 18 wherein the light 20 will be activated when one approaches the step to enter the recreational vehicle. The light motion sensor 22 on the top surface of the light bar 18 will activate lighting when one begins to exit the recreational vehicle. Thus, no matter which direction an individual is moving, either towards or away from the light bar 18, the lights 20 will illuminate wherein the edge of the step 21 will be clearly defined. Once the individual is out of range from the motion sensor 22, the light 20 will extinguish.

It is a related feature of the invention that it is lightweight. For example, one embodiment of the present invention weighs about 5 pounds such that loads placed on the existing step assembly 10 of the recreational vehicle are minimized, and wherein the lighted step assembly 2 is easy to carry and install.

While various embodiment of the present invention have been described in detail, it is apparent that modifications and alterations of those embodiments will occur to those skilled in the art. However, it is to be expressly understood that such modifications and alterations are within the scope and spirit of the present invention, as set forth in the following claims.

What is claimed is:

1. A lighting mechanism adapted for attachment to a recreational vehicle step comprising:
a tread plate adapted to connect with a step, the tread plate including an aperture for receiving a stud;
a light bar with a stud for operable engagement with the aperture of the tread plate, the light bar also including a light source operably connected to at least one motion detector and a power source.

2. The mechanism of claim 1, wherein the light source is at least one of a bulb and a light emitting diode.

3. The mechanism of claim 1, wherein the power source is at least one battery.

4. The mechanism of claim 1, wherein the tread plate includes a plurality of grooves.

5. A step assembly comprising:
at least one step having an integrated light source positioned thereon;
at least one motion sensor operably connected to the light source that activates the integrated light source when an individual approaches the step.

6. The step assembly of claim 5, wherein the at least one step includes a plurality of treads.

7. The step assembly of claim 5, wherein the at least one step includes a name plate.

8. The step assembly of claim 5, further comprising a power source operably connected to the motion sensor and the integrated light source, the power source being at least one of a battery, a generator, an alternator, a wind mill, a solar panel, a capacitor and a fuel cell.

9. The step assembly of claim 5, wherein the integrated light source is selectively connected to the step.

10. A lighting mechanism adapted for attachment to a step comprising:
a traction enhancing mechanism adapted to connect with a step, the traction enhancing mechanism including an aperture for receiving a fastening means;
a lighting means connected to the traction enhancing mechanism;
a motion detecting means operably connected to the lighting means; and
wherein the lighting means is selectively activated when the motion detection means senses the presence of an individual or animal.

11. The lighting mechanism of claim 10, wherein the traction enhancing mechanism is a tread plate that engages a top surface and a front surface of the step, the tread plate also including a plurality of apertures positioned on a front panel thereof that are adapted to accommodate fasteners for the connection of the lighting means.

12. The lighting mechanism of claim 10, wherein the traction enhancing mechanism is a member adapted to be permanently fastened to the step.

13. The lighting mechanism of claim 10, wherein the lighting means is a light bar that includes at least one light source, the light bar being adapted to interconnect to the traction enhancing mechanism.

14. The lighting mechanism of claim 13, wherein the light source is at least one of a bulb and a light emitting diode.

15. The lighting mechanism of claim 10, further including a power source operably connected to the lighting means and motion detecting means.

16. The lighting mechanism of claim 15 power source being at least one of a battery, a generator, an alternator, a wind mill, a solar panel, a capacitor and a fuel cell.

17. The lighting mechanism of claim 10, wherein at least one of the traction enhancing mechanism and the lighting means include a plurality of grooves.

18. The lighting mechanism of claim 10, wherein the traction enhancing mechanism includes a name plate.
